(19) United States
(12) Patent Application Publication
(10) Pub. No.: US 2009/0197001 A1
(43) Pub. Date: Aug. 6, 2009

(54) FLUID APPLICATOR ASSEMBLY

(76) Inventors: Shawn Donegan, Lakewood, OH (US); Charles Thur, Broadview Heights, OH (US); Mark Cipolla, Chardon, OH (US); Paul Stephens, Twinsburg, OH (US)

Correspondence Address: Fay Sharpe LLP, 1228 Euclid Avenue, 5th Floor, The Halle Building, Cleveland, OH, 44115, US

(21) Appl. No.: 12/282,808

(22) PCT Filed: Mar. 12, 2007
(86) PCT No.: PCT/US07/06167

§ 371 Date: Nov. 19, 2008

Related U.S. Application Data
(60) Provisional application No. 60/781,686, filed on Mar. 13, 2006.

(51) Int. Cl. B05D 3/12; B05C 17/02

(52) U.S. Cl. 427/355; 401/208; 29/428

(57) ABSTRACT

A low pressure fluid applicator assembly includes a frame having a first roller mounting location and a second roller mounting location spaced from the first roller mounting location such that first and second rollers can mount to the frame having their central axes spaced from one another. The frame includes first and second side rails selectively connected to one another by a strut that is not integrally formed with at least one of the first and second side rails. A fluid supply member is connected to the frame and spaced from the first roller mount. The fluid supply tube is adapted to communicate with an associated fluid source.

### CROSS REFERENCE TO RELATED APPLICATIONS

This application claims priority from U.S. Provisional Patent Application Ser. No. 60/781,686 filed Mar. 13, 2006, which is expressly incorporated herein by reference, in its entirety.

This application also incorporates by reference U.S. Provisional Patent Application Ser. No. 60/530,097 filed Dec. 16, 2003, and International Publication Number WO 2005/058510 A1.

### BACKGROUND OF THE INVENTION

Known methods of painting use a conventional roller assembly, for example, a roller such as a cardboard or plastic having an absorbent material such as nylon, reticulated foam, felt, lambs wool or a sponge that temporarily holds a liquid (e.g., paint) until the liquid is applied to a work surface. This is widely used to cover large surface areas typically where not much trim or detail painting is required.

Still another method is to modify the conventional roller so that it receives paint under relatively high pressure through the cylindrical roller and permeates the inner surface of the absorbent material where it passes to the external surface thereof for application to an associated work surface. Known pressure roller assemblies supply paint to an internal passage of the roller at pressures of approximately 1000 psi. The internal passage is fed 360° around its periphery which often results in too much fluid being delivered to the roller. When too much fluid has been delivered to the roller, the roller tends to slide as opposed to rolling.

Known pressure roller assemblies generally include a roller tube, a paint distributor, an auger, and a roller. The roller is similar to a conventional cylindrical paint roller; however, the roller must be able to allow paint to be delivered from inside the roller and travel to an outer surface of the roller. Such a construction makes these rollers more expensive than conventional rollers. The auger is received by the roller and advances the paint within the hollow portion of the roller. The paint distributor is received by the auger and the roller. The paint distributor typically is a cylindrical member having a plurality of holes through which the paint travels towards the auger and the roller. This subassembly, which includes the roller, the auger, and the paint distributor, is sealed at each end by an end cap. The subassembly is then mounted on a roller tube, which is hollow so that paint can flow through the tube toward the subassembly. Paint travels through the tube and into the subassembly under pressure that can be as great as 1000 psi.

Such pressure roller assemblies as described above allow an operator to typically cover more surface area during an application job than a conventional paint roller. Nevertheless, many drawbacks are attributed to these pressure roller assemblies. First, the known assembly operates at high pressures, which can cause stress to the components of the assembly as well as fatigue to the operator due to the high pressure working against the operator. The known assembly also requires a special roller that includes small fluid ports that can become blocked resulting in a malfunctioning painting apparatus. Also, the roller can become saturated resulting in splatter and drips during the painting process. Known pressure rolling assemblies also include many sealed wear parts that can become worn and leak.

Accordingly, it is desirable to provide a painting apparatus that overcomes the shortcomings mentioned above.

### BRIEF DESCRIPTION

In accordance with one aspect of the present invention, a low pressure fluid applicator assembly includes a frame having a first roller mounting location and a second roller mounting location spaced from the first roller mounting location such that first and second rollers can mount to the frame having their central axes spaced from one another. The frame includes first and second side rails selectively connected to one another by a strut that is not integrally formed with at least one of the first and second side rails. A fluid supply member is connected to the frame and spaced from the first roller mount. The fluid supply tube is adapted to communicate with an associated fluid source.

In accordance with another aspect of the present invention, a method of manufacturing a low pressure fluid applicator assembly is disclosed. A strut is provided having a length predetermined by a length a roller that is to mount to the assembly. A first side rail is attached to a first end section of the strut. A second side rail is attached to a second end section of the strut. The first and second side rails include roller mounting locations spaced from one another such that a first roller and a second roller can mount to the frame. The rollers have their central axes spaced from one another. A fluid supply tube is attached to a first end section of at least one of the first and second side rails. The fluid supply tube is configured to communicate with an associated fluid source.

In accordance with yet another aspect of the present invention, a method of applying a high solid coating with a low pressure fluid applicator assembly is provided. The fluid applicator assembly includes a frame including a strut and first and second side rails attached to opposing end sections of the strut. A fluid supply member attached to the frame is fluidly connected to a source of high solid coating. A height adjustable spiked member is connected to the frame. At least one roller is releasably attached to the frame between the fluid supply member and the spiked member. A handle bar is pivotally connected to the frame. The handle bar is adapted to attach to an associated handle for maneuvering the assembly. The method comprises delivering a predetermined amount of the high solid coating to at least one of an associated surface to be covered by the coating and at least one roller of the fluid applicator assembly. The high solid coating is applied over a predetermined portion of the associated surface with the at least one roller of the assembly. The high solid coating is spiked with the spiked member of the assembly which releases bubbles trapped in the coating after it has been applied.

In accordance with still yet another aspect of the present invention, a low pressure fluid applicator assembly comprises a frame having a first roller mounting location and a second roller mounting location spaced from the first roller mounting location such that first and second rollers can mount to the frame having their central axes spaced from one another. The frame includes first and second side rails selectively connected to one another by a strut. A fluid supply member is connected to the frame and spaced from the first roller mount. The fluid supply tube is adapted to communicate with an associated fluid source. A spiked member is connected to the frame and spaced from the second roller mount.

### BRIEF DESCRIPTION OF THE DRAWINGS

FIG. 1 is an exploded view of a fluid applicator assembly.

FIG. 2 is a top perspective view of the fluid applicator assembly of FIG. 1.

FIG. 3 is a bottom perspective view of the fluid applicator assembly of FIG. 1.

FIG. 4 is an exploded view of an alternative fluid applicator assembly.

FIG. 5 is a top perspective view of the fluid applicator assembly of FIG. 3.

FIG. 6 is a bottom perspective view of the fluid applicator assembly of FIG. 3.

### DETAILED DESCRIPTION

It should, of course, be understood that the description and drawings herein are merely illustrative and that various modifications and changes can be made in the structures disclosed without departing from the scope and spirit of the invention. Like numerals refer to like parts throughout the several views. It will also be appreciated that the various identified components of the fluid applicator assembly disclosed herein are merely terms of art that may vary from one manufacturer to another and should not be deemed to limit the present invention.

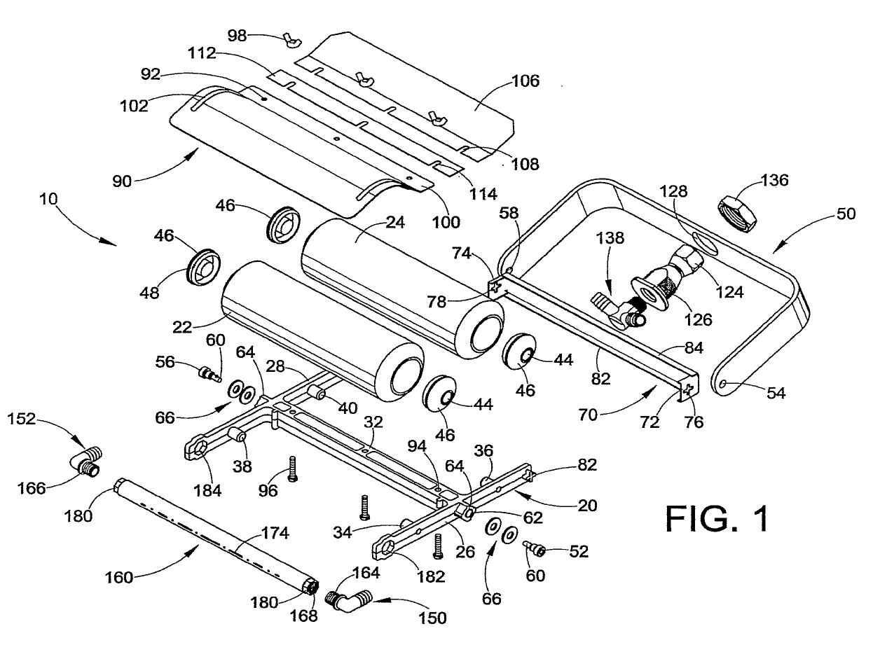

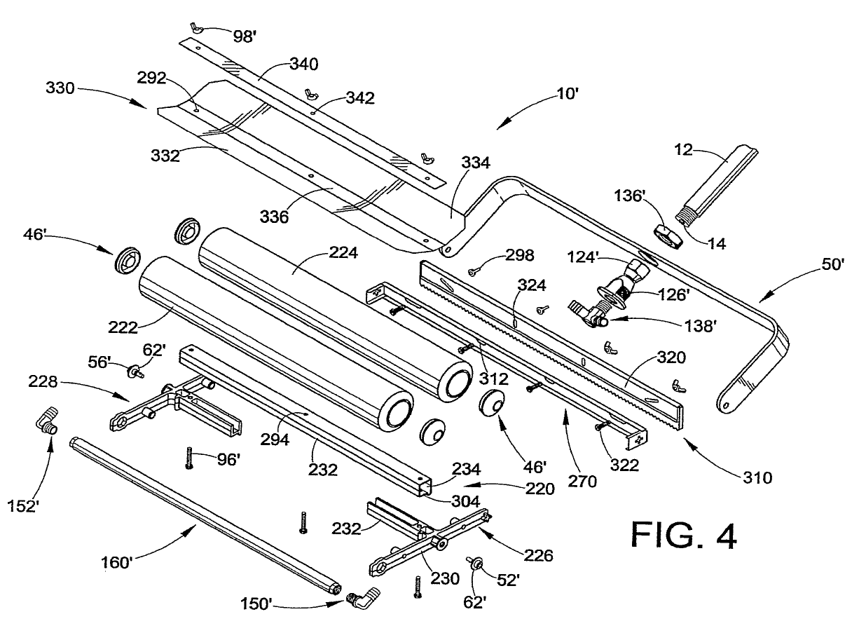

Referring now to the drawings, wherein the drawings illustrate an embodiment of the present invention only and are not intended to limit same, FIGS. 1-3 illustrate a fluid applicator assembly 10 attachable to a handle 12 (depicted in FIG. 4) having an internal passage 14 that communicates with a fluid supply. The fluid applicator assembly 10 will be described with reference to applying paint to a surface; however, it is to be understood that the assembly can be used to apply any conventional fluid or liquid to a surface, including, but not limited to, stain, primer, sealant, epoxies, cleaner, adhesive, pesticide, herbicide, etc. The handle 12, which is generally known in the art, typically includes a valve that can selectively open and close the passage 14 to control the flow of fluid through the handle. The pressure at which the fluid is under in the fluid applicator assembly can be much less (typically less than 50 psi) than the pressure at which paint is under in known pressure applicators. Nevertheless, fluid can be delivered at higher pressures, for example more viscous fluids. Typically in a present embodiment, the paint or liquid is delivered as measured by gallons per minute, and the pressure at which the paint or liquid is delivered is determined by the characteristics of the paint or liquid and the path through which it travels. The paint or liquid, for example, can be delivered at about 0.25 gallons to about 0.28 gallons per minute. Delivering the paint or liquid at lower pressures allows the fluid lines and other fluid assemblies to have larger diameters (nominally about ⅜″-1″), which lessens the likelihood of clogs or blockage in the fluid lines. Lower pressures also reduce the stress on the components of the assembly as well as limit fatigue to the operator caused by the pressure of the fluid through the handle.

According to the depicted embodiment, the fluid applicator assembly 10 includes an H-shaped frame 20, a first roller 22 mounted to the frame, a second roller 24 mounted to the frame, and a fluid supply assembly for supplying fluid to the rollers. Throughout the specification, the first roller 22 may be referred to as the upper roller and the second roller 24 may be referred to as the lower roller. This is simply for ease of understanding the figures and is not used to limit the assembly to any certain configuration. The rollers in the depicted embodiment are any conventional 9″ rollers; however, the H-shaped frame 20 can be made to accommodate rollers of any length, for example from two (2) inches to thirty-six (36) inches in length. Also, not only can rollers mount to the frame, other items such as cloth (both synthetic and natural fiber) pads, brushes, and the like can mount to the frame.

The frame 20 can include molded plastic components and extruded metal, e.g., aluminum, components. In the depicted embodiment, the frame 20 includes two parallel side rails, first side rail 26 and second side rail 28, that are interconnected by a cross member or strut 32. As shown in FIG. 1, the side rails 26 and 28 and the strut 32 are formed as an integrally formed, e.g., one-piece molded or cast plastic or metal piece or unit. Alternatively, to provide more flexibility in the manufacturing of the assembly 10 and to provide more options with regard to the length of rollers that the assembly can accommodate, the strut 32 can be selectively connected, e.g., via conventional fasteners, to the side rails 26 and 28, as opposed to being made as a single piece (see FIG. 4). In other words, three separate pieces, a strut and two side rails, attach to one another. Such a construction can allow the H-frame 20 to accommodate many different lengths of rollers, e.g., 7-inch, 9-inch, 12-inch, 18-inch, 36-inch, as well as metric units. The side rails 26 and 28 can be a stock item for each length of roller that the H-frame 20 can accommodate and a different length strut 32 can be provided as desired.

With reference to FIG. 4, which depicts an alternate assembly to the exploded view of FIG. 1 such that a detailed description of the assembly seems unnecessary (reference numerals with a single primed suffix (′) refer to like components), the frame can be configured such that the first and second side rails can selectively be connected to one another by a strut that is not integral with at least one of the first and second side rails. In the depicted embodiment, the frame 220 includes a separate strut 232, which can be extruded aluminum that attaches side rails 226 to side rail 228. The strut 232 can be hollow to receive a portion of each side rail to connect the two to one another. Particularly, each side rail can be T-shaped having a base 230 and a leg 232 extending generally perpendicular from a midsection of the base. The strut includes a cavity 234 dimensioned to receive the side rail leg. Conventional fasteners 96′ can be used to selectively connect the side rails 226, 228 to the strut 232. Alternative connections can be used, for example fasteners, a spring-loaded pin that fits into an opening, and other conventional fasteners that can be selectively fastened. The strut 232 can be any number of different lengths.

With reference back to FIGS. 1-3, each side rail 26 and 28 includes a pair of roller mounts 34, 36 and 38, 40 respectively. Roller mounts 34, 36 are located on opposite sides of the strut 32 and extend from the first side rail 26 towards the second side rail 28. Roller mounts 38, 40 are located on opposite sides of the strut 32 and extend from the second side rail 28 towards the first side rail 26. The side rails are sufficiently resilient such that they can be pulled apart from one another to allow for the mounting and removal of the rollers 22 and 24 from the frame 20, yet sufficiently rigid to maintain the rollers on the frame while painting. If desired, where the H-frame 20 is split, e.g., where the strut 32 selectively connects to the side rails 26 and 28, the frame can be made more rigidly so that removal of the rollers 22 and 24 requires removal of the strut 32.

The roller mounts in the illustrated embodiment are cylindrical protrusions that are dimensioned to receive openings 44 in end caps 46 that attach to the respective rollers 22 and 24. In alternative embodiments, the rollers can attach to the frame in other conventional manners, via pins, axles, fasteners, and the like; however, removal of the rollers without the need for hand tools, which can be done in the illustrated embodiment, is desirable. The end caps 46 are shown as having a tapered configuration where the outer wall of the end cap, i.e., the surface that is visible when the end cap attaches to the roller, tapers from the outer circumference of the end cap towards the respective side rail and the rotational axis of the roller. Alternatively, end caps that have a flatter, or more planar configuration can be provided. Flat end caps can allow for one strut to accommodate rollers of different lengths. In other words, where two different rollers each have a length and the difference between the lengths is not great, a flat end cap can mount to the longer roller and a tapered end cap can mount to the shorted roller, but the length of the strut can remain the same. Alternatively, the pitch of the taper can be modified to accommodate different sized rollers.

Additionally, small nubs or bumps 48 can be provided on the periphery of the end cap 44 that typically fits inside the roller. These nubs can be deformed slightly to allow an end cap having a predetermined diameter to fit a few different rollers each having a different inner diameter.

Roller mounts 34 and 38 are aligned with one another to define an axis about which the upper roller 22 rotates. Likewise, roller mounts 36 and 40 are aligned with one another to define an axis about which the lower roller 24 rotates. The axes about which the rollers rotate are spaced from the lowermost and uppermost ends of the frame 20 at least a distance greater than the outer radius of a conventional roller, which protects the rollers from inadvertently contacting the ceiling or the floor, for example, when painting a wall. The axes are also parallel to one another and reside in the same plane so that both rollers can contact the work surface at the same time.

A U-shaped handle bar 50 mounts to the frame 20 such that the handle bar 50 can pivot in relation to a central axis of the strut 32 of the frame. If desired, the handle bar 50 can mount elsewhere to the frame 20, for example at a location spaced from the strut 32. At this alternative location, the handle bar 50 can pivot about an axis that is parallel to the central axis of the strut 32. A first shoulder bolt 52 connects the frame 20 and the strut 32 at one side. The shoulder bolt is received in a first attachment opening 54 at a first end of the handle bar 50. A second shoulder bolt 56 extends through a second attachment opening 58 at a second end of the handle bar 50 for connecting the handle bar to the frame 20. A pin 60 of each shoulder bolt is received in an insert (not shown), e.g., a brass insert, that fits into an opening 62 of a projection 64 extending outwardly from each side rail 26, 28 of the frame 20. Accordingly, the handle bar 50 is pivotally attached to the frame 20 to rotate about the central axis of the strut. Washers 66, for example fabric washers, can fit around the shoulder bolts. Alternatively, the handle bar 50 can attach to the frame 20 in other conventional manners. For example, bolts that cooperate with nylon locks can be provided in lieu of the shoulder bolt and pin. The bolts with nylon locks assembly can inhibit the bolt from backing out of the opening in the frame when the frame is under stress.

A drip guard 70 attaches to a lower end of the frame 20. The drip guard includes first and second end walls 72 and 74 each having an opening 76 and 78, respectively. The openings 76 and 78 receive correspondingly shaped projections 82 (only one being illustrated) on the frame 20. In the depicted embodiment, the projections are cross-shaped members and the openings are also cross shaped. This configuration provides four bearing regions for the connection between the drip guard 70 and the frame 20. Since the side rails 26 and 28 are resilient, they can be flexed towards one another so that the projections can be inserted into the corresponding openings to attach the drip guard 70 to the frame 20. The drip guard can attach to the frame in other conventional manners, including fasteners, welding, etc.; however, a drip guard that is removable without the need for hand tools, such as the drip guard 70 in the depicted embodiment, allows for easier disassembly and cleanup. A more rigid attachment, e.g., welding and wrapping a portion of the drip guard around a portion of the H-frame, can provide for a more robust assembly 10 that can withstand striking the drip guard 70 against the floor during a painting operation. The side rails 26 and 28 can bottom out and contact the upper surface of the drip guard 70 so that any force on the drip guard, e.g. from contacting the floor, is transferred into the side rails, to further provide a more robust assembly.

The drip guard 70 also includes side walls 82 and 84 that can retain paint that falls onto the drip guard. The drip guard 70 can also provide another guard function where the drip guard protects the lower roller 24 from inadvertently contacting a surface that is at an angle, which will typically be perpendicular, to the surface being painted.

A first roller shield 90 attaches to the frame 20. The first shield 90 catches paint that splatters off the first roller 22. The shield 90 includes a plurality of fastener openings 92 that align with openings 94 in the strut 32 of the frame 20. Fasteners 96 extend through the openings 94 and 92 and receive a wing nut 98 to attach the shield 90 to the frame 20. The wing nut and fastener connection allows for easy removal of the shield 90 from the frame 20. The upper shield 90 has a length that is generally equal to or slightly longer than the length of the first roller 22.

The shield 90 is curved to complement the shape of the first roller 22 and an upper portion 100 of the shield 90 flattens out to become generally planar. The shield 90 includes corrugations or ribs 102 that are spaced on opposite ends of the shield 90. The corrugations 102 are parallel to one another and spaced from one another a distance equal to the length of the first roller 22. Not only do the corrugations 102 provide stiffness to the shield 90, which will be typically made from metal, but the indentions that extend toward the first roller 22 can catch any dripping or splattering of paint from the first roller 22 when the applicator device is used to apply paint in a horizontal direction. The corrugations 102 can also direct any excess liquid that contacts the shield 90 towards the lower roller 24 and/or the drip guard 70.

A second shield or lower guard 106 depends from the strut 32 and acts as a splatter shield for the lower roller 24. The lower guard includes a plurality of notches 108 that align with the openings 92 in the first shield 90 and the openings 94 in the strut 32 to receive the fastener 96. In the depicted embodiment, the lower shield 106 bends away from the strut 32 and is positioned close to the outer surface of the lower roller 24. The lower guard 106 also has a length that is at least approximately equal to the length of the lower roller 24. In an alternative embodiment, the lower shield 106 can be replaced by a wiper that contacts the lower roller 24 to remove any excess paint that builds up on the lower roller 24. The shields described above can also be formed as a single component, if desired.

A hold down bracket 112 attaches to the strut 32 of the frame 20 to retain the first shield 90 and the second shield 106. The hold down bracket 112 includes a plurality of notches 114 that align with notches 108 in the second shield 106 and openings 92 in the first shield 90 so that fasteners 96 can be received in the openings 94 and the strut 32 and the hold down bracket 112 can retain the first and second shields.

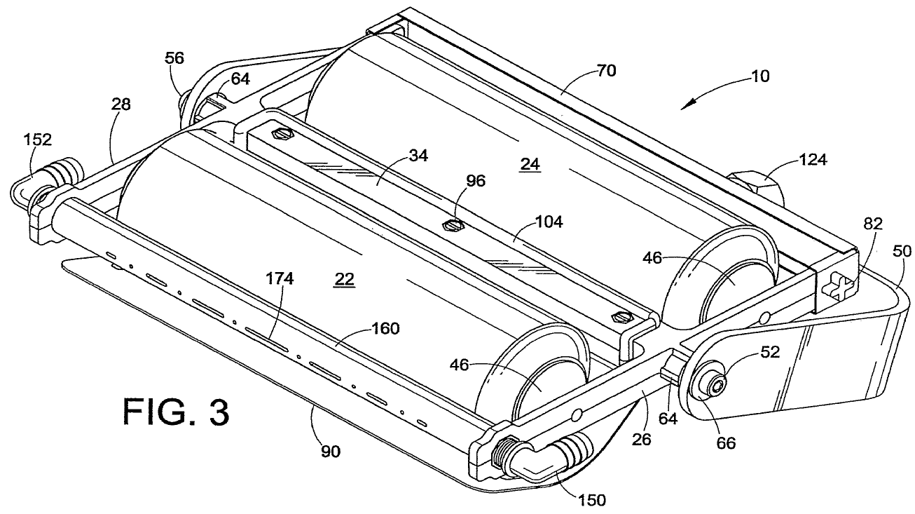

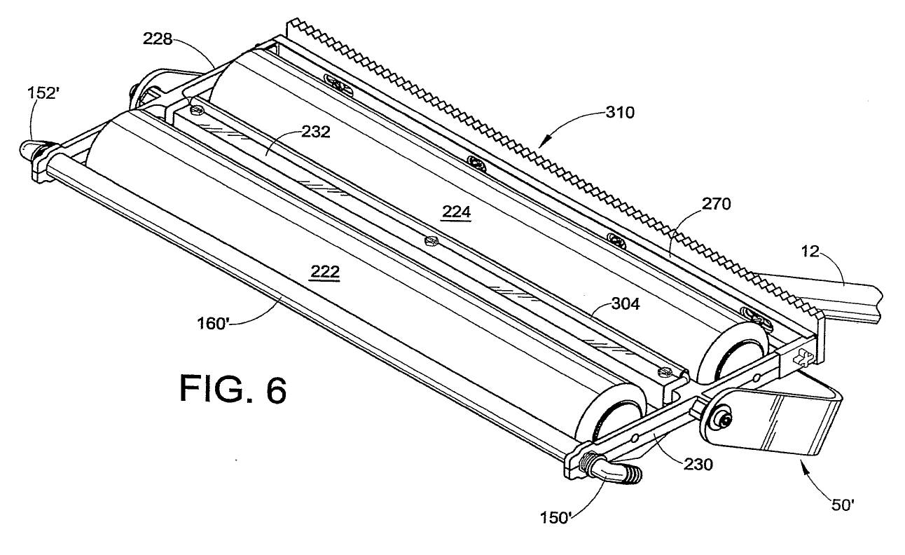

With reference to FIGS. 3 and 6, it should also be appreciated that the strut 34, 234 can also be shaped to inhibit fluid from dripping from the upper roller 22, 222 onto the lower roller 24, 224. The strut can be configured to include a projection 104, 304 that can take a number of different configurations, for example a teardrop shape, a flange-like shape and others, where the projection extends generally outwardly from the base shape, which is the depicted embodiment is rectangular, of the strut. The strut can be extruded to include the projection.

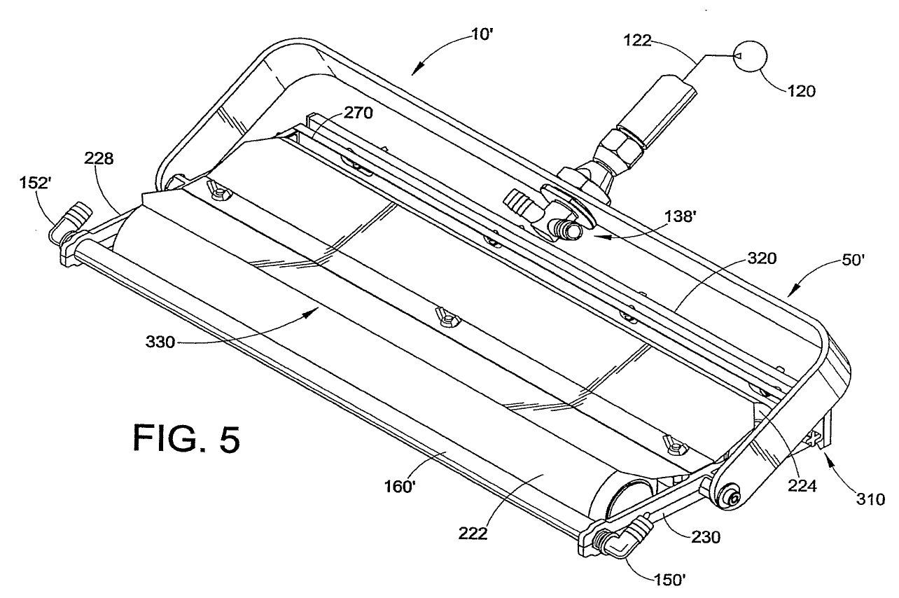

As mentioned above, the handle 12 includes a passage 14 through which fluid can be delivered to the assembly 10. A pump 120 via a disposable hose 122 (both being illustrated schematically in FIG. 5) delivers fluid to the passage 14 defined in the handle 12 (FIG. 4). The pump can be a conventional displacement pump or a peristaltic pump. By using a peristaltic pump, difficult fluids, for example corrosive fluids and fluids that contain solid particles, do not come in contact with movable components of the pump, as opposed to other known displacement pumps. Accordingly, a peristaltic can last much longer than known displacement pumps that are used for delivering fluid, e.g., paint and sealants, to applicators. Furthermore, by reversing the direction of the peristaltic pump, fluid that is in the hose 122 but has yet to be applied can be drawn back into a container (not shown) from which it is being pumped, which provides for a more effective clean-up. Since the fluid has only come in contact with the clean fluid delivery hose 122, the fluid can most likely be placed back into its container without destroying the integrity of the fluid in the container that has not yet been pumped. Furthermore, the fluid lines can simply be thrown away after usage. Therefore, if a fluid line freezes up, the fluid line can be removed from the peristaltic pump and replaced. This is not achievable if there is a freeze up in the known piston pumps, and the like.

Another advantage of using a peristaltic pump, a driven assembly of the peristaltic pump can be selectively removable from an output shaft of a motor that drives the driven assembly. Accordingly, one driven assembly can be manufactured that fits onto different motor and transmission assemblies. Therefore, if a higher torque or higher powered motor is desired, the same driven assembly can be used that is used with a lower powered motor and transmission assembly. Where desired, for example for home consumer operations, the motor in the peristaltic pump can be battery powered, for example using the rechargeable batteries that are common with power tools.

With reference back to FIG. 1, the handle fits into a swivel adapter 124. The swivel adapter 124 allows the handle to pivot about a point near the midsection of the handle bar 50, which can provide more flexibility with regard to the places that the assembly can apply fluids. The swivel adapter 124 is hollow to receive the handle at one end and contacts a bulk head fitting 126 at the other end. The bulk head fitting 126 is keyed, e.g., includes a flat surface that contacts a flat surface in an opening 128 in the handle bar 50 to preclude rotation of the bulk head fitting with respect to the handle bar 50. A swivel adapter retainer (not shown) fits into the swivel adapter 124 and connects inside the bulk head fitting 126 to attach the swivel adapter 124 to the bulk head fitting. A bulk head fitting nut 136 threads onto the bulk head fitting 126 to attach the bulk head fitting to the handle 50. The swivel adapter 124 can come in a variety of sizes to accommodate handles from different manufacturers. Also, the swivel adapter 124 allows for movement in and around a central axis of the adapter. The swivel adapter 124 also allows the positioning of a trigger (not shown), which controls the delivery of fluid to the assembly 10, to be placed in a position that is most comfortable for the person using the assembly.

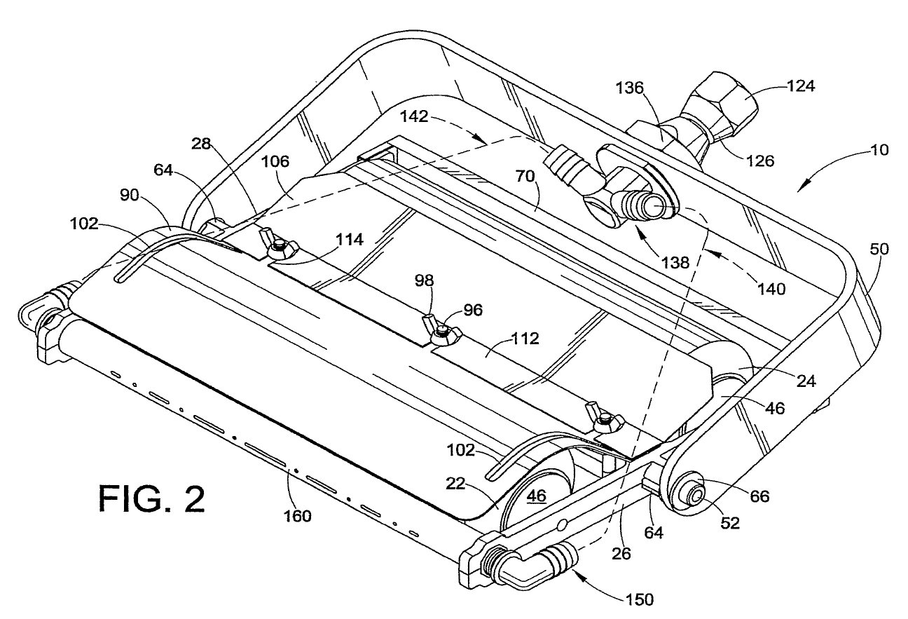

A Y-fitting 138 fits into the bulkhead fitting 126 and communicates with the pump fluid source assembly 120 (FIG. 5). First and second fluid supply lines 140, 142, respectively, (illustrated schematically in FIG. 2 and similar to the fluid supply lines depicted in International Publication Number WO 2005/058510 A1) connect to and communicate with the Y-fitting 138. The first fluid supply line 140 attaches to the Y-fitting 138 at one end and to a first elbow fitting 150 at the opposite end. Similarly, the second fluid line 142 attaches to the Y-fitting 138 at one end and to a second elbow fitting 152 at the opposite end. The fluid supply lines can be made from a very flexible plastic having a high memory to allow the U-shaped handle 50 to pivot in relation to the frame 20 nearly 180 degrees while still allowing paint to flow through the lines. With usage of the Y-fitting 138; however, since the branches of fitting extend towards the rear of the assembly, i.e., towards the shields 90 and 106, and the handle bar 50 typically pivots towards the shields with respect to the frame 20 when in use, the fluid supply lines do not have to be as flexible as when a tee fitting is used because there is not as great a tendency for the fluid supply lines to kink since the lines are spaced from the handle bar 50.

The first elbow 150 attaches to and communicates with a supply tube or member 160 at a first end and the second elbow 152 attaches to and communicates with the supply tube 160 at a second end. The elbow fittings 150 and 152 and the Y-fitting 138 are made to allow for connection of the fluid supply assembly that does not require hand tools, which is possible because the fluid traveling through the lines is not under a great amount of pressure. Each fitting can include a plurality of cylindrical ramps or barbs that incline upward in the direction that the supply line is pressed onto the fitting. The elbow fittings 150 and 152 also include a threaded end 164, 166 that is threaded into a threaded receptacle 168 in the supply tube 160. Other types of low pressure connections can be used instead of the aforementioned, for example the elbow fittings may be replaced and the supply lines can attach directly to the supply tube. Also, the elbow fittings 150 and 152 can include protrusions that extend radially outwardly. These protrusions can be axially spaced, with respect to the supply tube 160, from the side rails 26 and 28 to confine the side rails so that the side rails do not flex outwardly when fluid is being delivered to the supply tube and the supply tube exerts a stress on the side rails.

The supply tube 160, which can be made from a rigid plastic, can include a plurality of spaced apart openings, such as the illustrated elongated slots 174, through which fluid is dispensed. The fluid supply tube is depicted as a hollow cylinder; however, the tube can take a number of different configurations that allow fluid to be dispensed for use with the assembly. The elongated slots run parallel to the axes in which the rollers 22 and 24 rotate. In the illustrated embodiments, the slots 174 do not all have the same opening area. The most central slot 174 has the largest opening area, and the slots nearest the elbows 150 and 152 have a smaller opening area. This configuration promotes more even distribution of fluid onto the upper roller since the resistance is greater at the smaller slots (but the fluid does not travel as far in supply tube 160) while the resistance is less at the centrally located slots (where the fluid travels a greater distance in the supply tube). Instead of the plurality of elongated slots, the supply tube can include a single elongated slot through which fluid can exit the supply tube.

Paint travels from the fluid source through the handle 12 into the Y-fitting 138. From the Y-fitting 138, fluid travels through the first and second supply lines 140, 142 (depicted schematically), through the elbow fittings 150 and 152, respectively, into the fluid supply tube 160 and out the elongated slots 174. Since the fluid travels under low pressure, the supply lines, fittings and supply tubes can have relatively large diameters, as compared to known pressure assemblies. In the illustrated embodiment the supply lines, fittings and supply tube can have an internal diameter of about ⅜″; however a range of diameters from ⅛″ to ⅞″ and even larger are contemplated.

The supply tube 160 is adjustable. In the depicted embodiment, the supply tube 160 includes polygonal ends 180, which in the depicted embodiment are octagonal. The frame includes first and second polygonal openings 182 and 184 formed in the side rails 26 and 28, respectively that have a complementary shape to the ends of the supply tube. With such a configuration and since the side rails 26 and 28 are flexible, the supply tube 160 is able to rotate and lock into a number of different orientations, which are equal to the number of sides provided in the polygonal end, e.g., three different orientations for a triangular end and eight different orientations for an octagonal end. To rotate the supply tube 160, the side rails 26 and 28 are pulled away from the polygonal ends so that the polygonal ends are no longer located inside the complementarily shaped openings. The supply tube 160 is then rotated to a new orientation. Afterwards the side rails are allowed to return to their normal location with the polygonal end received in the complementarily shaped opening. Accordingly, the location of the elongated slots 174 in relation to the first roller 22 can change.

Since the assembly operates as a low pressure system, fluid discharges from the elongated slots 174 and travels over the outer surface of the supply tube 160 towards the first roller 22. As the fluid travels over the supply tube, it can fan out towards the ends of the first roller 22, which provides more even application of the fluid on the work surface. If fluid is being applied to a horizontal surface, e.g., a floor, the supply tube 160 can be rotated so that the slots 174 are positioned to deposit fluid directly on the floor, or so that the fluid must travel over the outer surface of the supply tube before contacting the floor. Also, the supply tube location can be changed. For example, instead of the strut 32 connecting the side rails, the supply tube 160 can be located between the first and second rollers.

With reference back to the depicted embodiment, the supply tube 160 is spaced from the upper roller 22 so that the upper roller can rotate, but the spacing can be minimal if desired. The wall thickness of the supply tube 160 or the location of the supply tube can be changed to adjust the location of the slots 174 with respect to the upper roller 22. The supply tube 160 connects to the frame 20 slightly below the uppermost end of the frame, which allows the frame to contact the ceiling, when a wall is being painted, before the supply tube contacts the ceiling. Typically when painting a vertical wall the slots 174 will be in the 12 o'clock position vertically above the upper roller and the frame 20 provides a standoff that precludes the supply tube 160 from contacting the ceiling on an upstroke. The upper shield 90, described above, also ends below the uppermost end of the frame 20 so that the shield does not contact the ceiling and bend towards the supply tube 160. Even though the upper and lower standoffs are depicted as integral parts of the frame 20 in the illustrated embodiment, in alternative embodiments, the standoffs can simply attach to the frame, the handle bar 50 or other member, so long as they inhibit incidental contact of a roller and/or supply tube with an undesired surface.

In lieu of the upper roller 22 being externally fed, as depicted in FIG. 1, the supply tube 160 can be inserted into the upper roller 22 and the roller could be internally fed. With such a configuration, however, the roller 22 would need to be of the type that would allow fluid to pass to an outer surface of the roller.

As indicated above, the fluid applicator assembly is useful in applying high solid epoxies, sealants, and the like, to roofs and floors. Oftentimes, these fluids are applied and then “spiked,” to release any bubbles that can get trapped in the fluid after it has been applied. Presently, a spiked, or porcupine, roller is used to pop these bubbles. With reference again to FIGS. 4-6, the fluid applicator assembly 10′ can include a spiked member 310 that attaches to an end of the H-frame 220. In the embodiment depicted, the spiked member 310 can attach to the frame adjacent where the drip guard would attach. As seen in FIG. 4, the spiked member 310 can attach to the drip guard 270 and the drip guard can include openings 312 to allow the spiked member 310 to attach to the drip guard.

Typically when the assembly 10′ is used to deliver high solid coatings, which can include epoxies, the handle bar 50′ is rotated so that the spiked member 310 is in the front of the assembly, i.e., facing the direction that the operator is pushing. This allows casting, or spiking, to occur on both the forward stroke and the rearward stroke.

The spiked member 310 can be made from a soft material, for example a soft elastomer, and measure the length of the rollers, or slightly longer or shorter. The spiked member 310 attaches to the frame 220 by being sandwiched between an outer retaining bracket 320 and the drip guard 270. Fasteners 322 are received through openings (not visible) in the spiked member 310 and through openings 324 in the retaining bracket 312 and receive wing nuts 298. Accordingly, instead of having a separate roller, typically operated by a separate person, to release bubbles in the fluid that has been applied, the assembly disclosed can apply the fluid and release the bubbles as it travels over the work surface. The release can occur simultaneously with the applying of the fluid.

The spiked member can be adjustable with respect to the height at which it extends over the work surface. The openings in the drip guard 270 can be slotted so that the spiked member can be mounted at different locations along the slotted opening.

A roller shield 330 attaches to the frame 220. The shield catches paint that splatters off both the first roller 222 and the second roller 224. The shield 90 includes a plurality of fastener openings 292 that align with openings 294 in the strut 232 of the frame 220. Fasteners 96′ extend through the openings 294 and 292 and receive a wing nut 98′ to attach the shield 330 to the frame 220. The wing nut and fastener connection allows for easy removal of the shield from the frame. The roller shield has a length that is generally equal to or slightly longer than the length of the first and second rollers. The shield 330 includes an upper angled section 332 for the first roller 222, a lower angled section 334 for the second roller 224 and a generally planar section 336 connecting the upper and lower sections. The planar section includes the openings 292. A hold down bracket 340 attaches to the strut 232 of the frame 220 to retain the roller shield 330. The hold down bracket includes a plurality of openings 342 that align with the shield openings 292 and the strut openings 294 so that fasteners 96′ can be received in the openings.

A clamshell housing (not shown) can be provided to cover the fluid applicator assembly. The housing, which can be made similar to a blister pack, can generally conform to the shape of the assembly. Such a housing can be useful when one does not wish to clean the device after painting, for example the painter has stopped working for the day but will continue his work in the morning. The painter can place the assembly in the clamshell housing and cover the assembly so that the rollers do not dry out overnight. The clamshell housing can also be useful when shipping the product.

The fluid applicator assembly has been particularly described to allow one skilled in the art to make and use the invention and to disclose the best mode. The description was not intended to limit the invention to only those embodiments that have been described. As just one example, the assembly can include only one roller or multiple, i.e., greater than two, rollers. The invention is limited only by the appended claims and the equivalents thereof.

What is claimed is:

1. A low pressure fluid applicator assembly comprising:
a frame having a first roller mounting location and a second roller mounting location spaced from said first roller mounting location such that first and second rollers can mount to said frame having their central axes spaced from one another, the frame comprising first and second side rails selectively connected to one another by a strut that is not integrally formed with at least one of said first and second side rails; and
a fluid supply member connected to said frame and spaced from said first roller mount, said fluid supply tube adapted to communicate with an associated fluid source.

2. The assembly of claim 1, wherein said frame is generally H-shaped.

3. The assembly of claim 1, wherein at least one end section of said strut defines a cavity dimensioned to receive a portion of at least one of said first and second side rails.

4. The assembly of claim 3, wherein at least one of said first side rail and said second side rail is generally T-shaped including a base and a leg extending from said base, a portion of said leg being received in said cavity.

5. The assembly of claim 1, wherein said strut is not integrally formed with said first side rail and said second side rail.

6. The assembly of claim 1, further comprising a spiked member connected to said frame and spaced from said second roller mount, said spiked member configured to release bubbles trapped in an associated fluid after the fluid has been applied to an associated surface by at least one of said first and second rollers.

7. The assembly of claim 6, wherein at least a portion of said spiked member includes a plurality of projections formed of a soft, resilient material.

8. The assembly of claim 6, further comprising a drip guard attached to said frame, said spiked member being connected to said drip guard.

9. The assembly of claim 1, further comprising a handle bar pivotally connected to said frame, said handle bar being adapted to attach to an associated handle for maneuvering the assembly.

10. The assembly of claim 9, further comprising a fitting assembly releasably connected to said handle bar and said fluid supply member, said fitting assembly including an opening dimensioned to receive the associated handle and a Y-fitting having first and second branches extending toward opposing end sections of said fluid supply member, each branch defining a passage through which fluid can flow into said fluid supply member.

11. The assembly of claim 1, wherein said fluid supply member is mounted spaced from said first roller and is rotatable with respect to said frame between at least a first position where fluid exits a discharge opening and flows over an outer surface of the fluid supply member toward said first roller and a second position where fluid exits said discharge opening and falls onto a surface to which fluid is to be applied.

12. The assembly of claim 11, wherein said fluid supply member includes a polygonally shaped portion that is received in a complementarily shaped opening in said frame.

13. The assembly of claim 1, wherein said fluid supply member includes a plurality of discharge openings, at least one discharge opening having an opening area that is greater than an opening area of another discharge opening.

14. A method of manufacturing a low pressure fluid applicator assembly comprising:
providing a strut having a length predetermined by a length a roller that is to mount to the assembly;
attaching a first side rail to a first end section of said strut;
attaching a second side rail to a second end section of said strut, said first and second side rails including roller mounting locations spaced from one another such that a first roller and a second roller can mount to said frame, said rollers having their central axes spaced from one another; and
attaching a fluid supply tube to a first end section of at least one of said first and second side rails, the fluid supply tube being configured to communicate with an associated fluid source.

15. The method of claim 14, further comprising attaching a height adjustable spiked member to a second end section of at least one of said first and second side rails.

16. The method of claim 14, further comprising attaching a drip guard to said frame, said spiked member being releasably connected to said drip guard.

17. The method of claim 14, further comprising:
pivotally connecting a handle bar to said frame, said handle bar being adapted to attach to an associated handle for maneuvering the assembly; and
attaching a fitting assembly to said handle bar for fluidly connecting an internal passage defined by the associated handle and the fluid supply tube, said fitting assembly including a Y-fitting having first and second branches extending toward opposing end sections of said fluid supply tube, each branch defining a passage through which fluid can flow into said fluid supply tube.

18. The method of claim 14, further comprising attaching at least one shield to said frame for preventing splattering of fluid, said at least one shield including a strengthening member for providing stiffness to said at least one shield.

19. A method of applying a high solid coating with a low pressure fluid applicator assembly, the fluid applicator assembly including:
a frame including a strut and first and second side rails attached to opposing end sections of the strut,
a fluid supply member attached to the frame fluidly connected to a source of high solid coating;
a height adjustable spiked member connected to the frame;
at least one roller releasably attached to the frame between the fluid supply member and the spiked member, and
a handle bar pivotally connected to the frame, said handle bar being adapted to attach to an associated handle for maneuvering the assembly,
the method comprising:
delivering a predetermined amount of the high solid coating to at least one of an associated surface to be covered by the coating and at least one roller of the fluid applicator assembly;
applying the high solid coating over a predetermined portion of the associated surface with the at least one roller of the assembly; and
spiking the high solid coating with the spiked member of the assembly which releases bubbles trapped in the coating after it has been applied.

20. The method of claim 19, wherein the spiking of the high solid coating occurs simultaneous with the applying of the coating.

21. A low pressure fluid applicator assembly comprising:
a frame having a first roller mounting location and a second roller mounting location spaced from said first roller mounting location such that first and second rollers can mount to said frame having their central axes spaced from one another, the frame including first and second side rails selectively connected to one another by a strut;
a fluid supply member connected to said frame and spaced from said first roller mount, said fluid supply tube adapted to communicate with an associated fluid source; and
a spiked member connected to said frame and spaced from said second roller mount.

22. The assembly of claim 21, further comprising a drip guard connected to said frame, said spiked member being height adjustably connected to said drip guard.
